(19) United States
(12) Patent Application Publication
(10) Pub. No.: US 2012/0091611 A1
(43) Pub. Date: Apr. 19, 2012

(54) IMPRINT METHOD AND APPARATUS

(75) Inventor: Masakatsu Yanagisawa, Kamitsuga-gun (JP)

(73) Assignee: CANON KABUSHIKI KAISHA, Tokyo (JP)

(21) Appl. No.: 13/268,114

(22) Filed: Oct. 7, 2011

(30) Foreign Application Priority Data
Oct. 13, 2010 (JP) 2010-230648

(51) Int. Cl. B29C 59/02

(52) U.S. Cl. 264/40.1; 425/135

(57) ABSTRACT

An imprint apparatus includes a detection unit configured to detect a mark formed on the mold and a mark formed on the substrate corresponding to a target transfer position, and a control unit configured to obtain information indicating relative position between a mark formed on the mold and a mark formed on the substrate corresponding to the target transfer position. The detection unit detects a mark formed on the mold and a mark formed on the substrate corresponding to the target transfer position, in a state where position of the mold and the substrate is aligned. The control unit performs alignment between the mold and the substrate so that the relative position when the mold and the transfer material are in contact with each other at the target transfer position in the state.

### BACKGROUND OF THE INVENTION

1. Field of the Invention

Embodiments of the present invention relate to an imprint method and apparatus for coating a substrate with a transfer material and transferring a pattern of a mold thereto.

2. Description of the Related Art

An imprint technique is a technique in which a mold having a formed micropattern is used as an original to form the micropattern on a transfer material applied on a substrate. More specifically, the micropattern may be formed by applying a transfer material on a substrate such as a silicon wafer or glass plate, and by curing the transfer material while the pattern of the mold is pressed against the transfer material. Imprint techniques which are now in practical use are a heat cycle method and photo-curing method.

In the imprint technique, a high accuracy is required for alignment between the substrate and the mold. As a method for conventional alignment, in a case where a pattern is formed on a plurality of shots on the substrate, alignment measurements of the substrate and the mold are performed for each shot. More specifically, as discussed in Japanese Patent Application Laid-Open No. 2007-281072, alignment operation is performed by using what is called a die-by-die measurement, in which marks formed on each of the substrate and the mold are observed and the displacement amount is corrected.

However, the die-by-die measurement had a problem that a position of a mark cannot be accurately detected, and the alignment cannot be properly performed, due to a process factor in substrate manufacturing such as film loss of a foundation layer, which is often observed in shots in the periphery of the substrate.

On the other hand, as a method for alignment in a semiconductor exposure apparatus, what is called a global alignment process has become mainstream. In the global alignment process, marks of several typical shots are measured, and statistical processing is performed based on the measurements, thereby molding all shots by using the same index. The global alignment process leads to an enhancement of overlay accuracy, since an influence of mark misalignment caused by the process factor in the periphery of the substrate may be reduced by appropriately selecting typical shots. For this reason, even in the imprint apparatus, an application of the global alignment process to the alignment operation is considered.

However, in the imprint apparatus, at least one of the transfer material and the mold is pressed. At this time, a reaction force is applied to a main body of the imprint apparatus, and it is conceivable that misalignments occur in the mold or the substrate.

For this reason, even if the alignment is made on the basis of a target transfer position on the substrate acquired by the global alignment process, there is a problem that the above-described misalignments of the mold and the substrate will be superimposed at the target transfer position on the substrate during imprint operation. Thus, relative position between the shot on the substrate and the pattern formed on the mold will be shifted.

### SUMMARY OF THE INVENTION

One disclosed feature of the embodiments of the present invention is directed to transferring the pattern more accurately with respect to the target position on the substrate, when a position alignment is performed on the basis of a target transfer position on a substrate acquired by a global alignment process.

According to an aspect of the embodiments, an imprint apparatus transfers a pattern formed on a mold to a transfer material provided in a substrate. The imprint apparatus includes a detection unit configured to detect a mark formed on the mold and a mark formed on the substrate corresponding to a target transfer position obtained by detecting a plurality of marks formed on the substrate, and a control unit configured to obtain information indicating relative position between a mark formed on the mold and a mark formed on the substrate corresponding to the target transfer position, by using a detection result of the detection unit, and to perform alignment between the mold and the substrate by using the information. The detection unit detects a mark formed on the mold and a mark formed on the substrate corresponding to the target transfer position, in a state where position of the mold and the substrate is aligned before coming into contact each other, in order to transfer the pattern to the target transfer position. The control unit obtains information indicating the relative position in the state where the position is aligned, and performs alignment between the mold and the substrate so that the relative position when the mold and the transfer material are in contact with each other at the target transfer position, coincides with the relative position when the alignment therebetween is achieved.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

One disclosed feature of the embodiments may be described as a process which is usually depicted as a flowchart, a flow diagram, a timing diagram, a structure diagram, or a block diagram. Although a flowchart or a timing diagram may describe the operations or events as a sequential process, the operations may be performed, or the events may occur, in parallel or concurrently. In addition, the order of the operations or events may be re-arranged. A process is terminated when its operations are completed. A process may correspond to a method, a program, a procedure, a method of manufacturing or fabrication, a sequence of operations performed by an apparatus, a machine, or a logic circuit, etc.

FIG. 1 illustrates an imprint apparatus according to a first exemplary embodiment.

FIG. 2 is a flowchart illustrating an imprint method according to the first exemplary embodiment.

FIG. 3A illustrates a mark arrangement example on a wafer according to the first exemplary embodiment.

FIG. 3B illustrates an arrangement example of marks on the wafer, when a shot is divided into a plurality of regions.

FIG. 4A illustrates, while a mold and a resin are in a non-contact with each other, a state in which alignment measurement of the mold and the wafer is performed.

FIG. 4B illustrates, while the mold and the resin are in contact with each other, a state in which the alignment measurement of the mold and the wafer is performed.

FIG. 5A is a side view of the mold used in the first exemplary embodiment.

FIG. 5B is a diagram of the mold used in the first exemplary embodiment as viewed from a surface on which the pattern is formed.

FIG. 6 is a flowchart illustrating an imprint method according to a second exemplary embodiment.

### DESCRIPTION OF THE EMBODIMENTS

Various exemplary embodiments, features, and aspects of the invention will be described in detail below with reference to the drawings.

Hereinbelow, exemplary embodiments of the present invention will be described in detail based on the attached drawings.

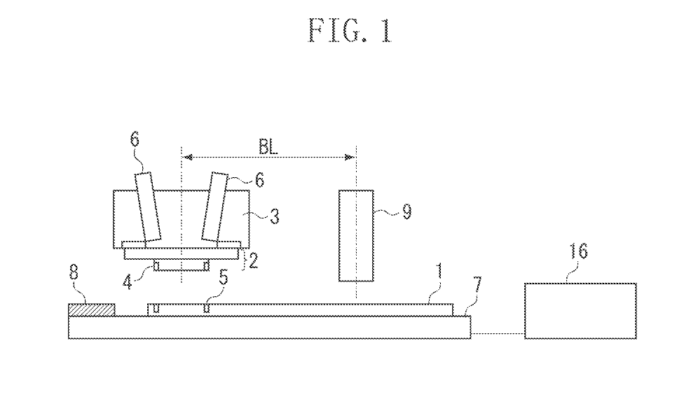

FIG. 1 illustrates an imprint apparatus according to a first exemplary embodiment. The imprint apparatus in FIG. 1 includes a wafer stage 7 that holds a substrate (wafer 1), and a structure 3 that holds a mold 2 on which a micropattern is formed. A mark 4 is formed on the mold 2, and a mark 5 is formed on the wafer 1. The mark 5 is provided on a layer already formed on the wafer 1, for example, in the course of forming a multi-layer substrate. Further, the imprint apparatus includes detectors (detection units) 6 that detect the mark 4 and the mark 5, and measure relative positions, and a detector 9 used for performing global alignment measurement. Furthermore, the wafer stage 7 is provided with a stage reference mark 8 that acts as a reference for determining a position of the wafer stage 7. Additionally, the imprint apparatus includes an arithmetic processing apparatus 16 that controls these operations of the imprint apparatus. Additionally, the imprint apparatus in FIG. 1 includes a laser interferometer or an encoder (not illustrated) for measuring a position of the wafer stage 7. The laser interferometer or the encoder measures the position of the wafer stage 7, using the measured position when initialized as a reference.

In the present exemplary embodiment, descriptions will be given using the wafer 1 as the substrate, but other substrates such as glass substrate may be also used, instead of the wafer. Further, it is only necessary for the detector 6 to be able to detect the mark 5 on the wafer 1 and the mark 4 of the mold 2 in order to obtain relative position between the wafer 1 and the mold 2. As the detector 6, a detector with an image forming optical system formed inside to observe the mark 4 and the mark 5 may be used. As a method for detecting positions of the marks, images of both marks may be observed, or interference signal obtained by synergistic effect such as moiré of both marks may be detected.

When a relative position between the wafer 1 and the mold 2 before imprint operation is measured, the wafer 1 and the mold 2 need not be simultaneously measured. A relative position between the mark 4 and the mark 5 may be measured by measuring the position of the mark 4 of the mold 2, and the position of the mark 5 on the wafer 1, with respect to a reference position (e.g., a mark or a sensor surface) formed inside the detector 6.

The detector 9 is formed outside the pattern center of the mold 2. The closer the detector 9 to the center of the pattern, the smaller the baseline amount (BL) becomes, and as a result, influence of errors caused by thermal deformation or temporal change of the main body and the structure 3 mounted thereon may be reduced. The baseline amount is a distance (including direction) between a position “A” determined by measuring (observing) the stage reference mark 8 with, for example, the detector 9, and a position “B” determined by measuring (observing) the mark 4 of the mold 2 and the stage reference mark 8, with the detector 6. The position “A” and the position “B” are determined by the detector 9 or the detector 6 observing the mark and by an interferometer or an encoder (not illustrated) measuring the position of the wafer stage 7 when predetermined conditions are satisfied. If the baseline amount is found, a predetermined positional relationship under the detector 9 determined by the detector 9 observing the mark 5 and the mark 12 of the wafer 1, may be reproduced at a destination of the movement equivalent to the baseline amount (under the mold 2 observed by the detector 6). In other words, the baseline amount is information including distance and direction.

For the global alignment measurement, the detector 6 may be also used instead of the detector 9. In this case, since the need for measurement of the baseline amount (BL) is eliminated, it leads to enhancement of productivity.

Furthermore, when the detector 6 is used in place of the detector 9, a region associated with driving the wafer stage 7 which is required for measurement of the wafer by the detector 9, is unnecessary, and as a result, the apparatus may be designed to require only a small installed area. However, since the detector 6 simultaneously measures a plurality of marks within one shot, a plurality of detectors 6 need to be provided. For this reason, an installation place is limited, and thus the detector 6 with increased numerical aperture (NA) cannot be provided. Therefore, in order to secure process responsiveness, the detector 9 having a large NA and the detector 6 are used in combination. Alternatively, it is also desirable to selectively use them.

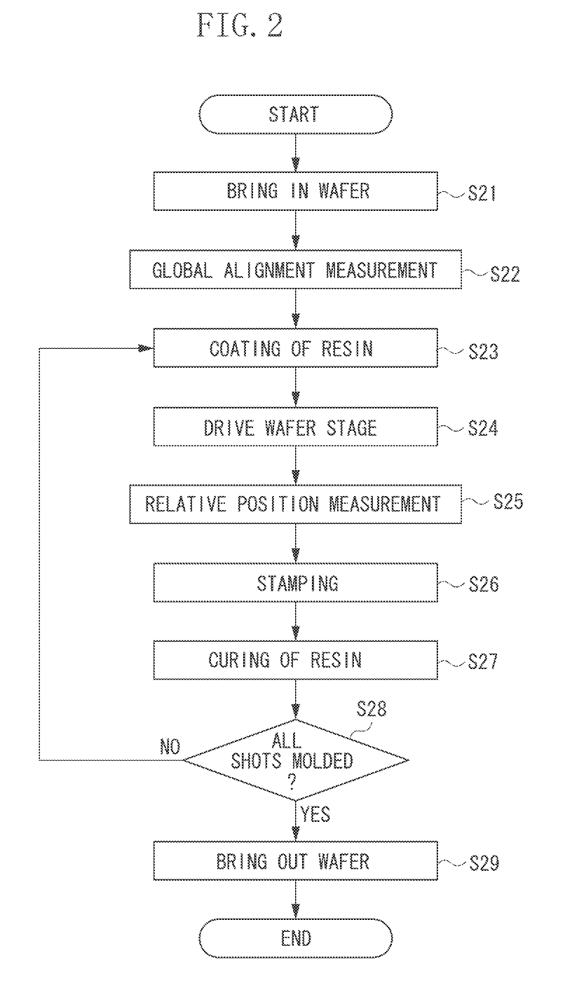

Next, an imprint method according to the first exemplary embodiment will be described with reference to the flowchart in FIG. 2.

In operation S21, a new wafer 1 is brought into the imprint apparatus, and is held by the wafer stage 7. The held wafer 1 is fed under the detector 9, by movement of the wafer stage 7.

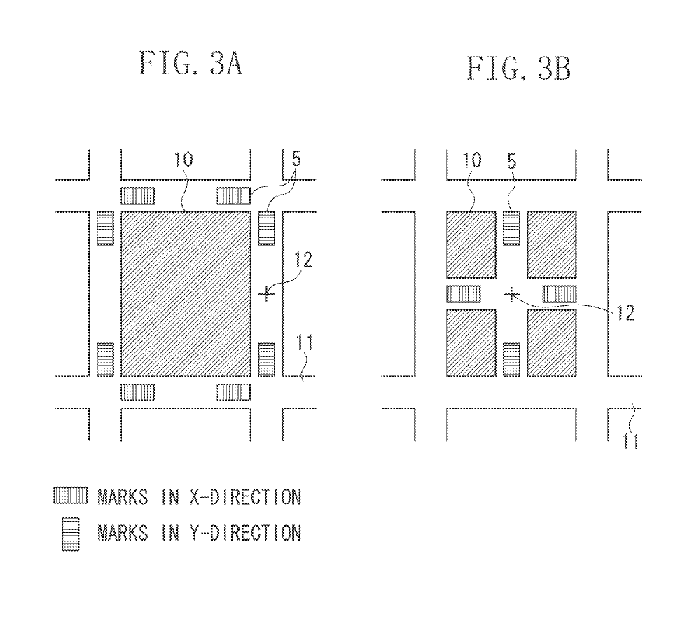

In operation S22, the global alignment measurement is performed. The detector 9 optically observes an alignment mark 12 of several typical shots (sample shots), from among a plurality of shots formed on the wafer 1, and detects a positional displacement amount between measurement position of the detector 9 and the alignment mark 12. The measurement position of the detector 9 is a position that acts as a reference for measurement of the detector 9. The measurement position of the detector 9 is, for example, a position defined by a mark disposed on an optical path of the detector 9 so as to be superimposed on an observed image of the detector 9, or an observation center of the detector 9 set in advance as the center of the observed image of the detector 9. The positional displacement amount, herein used, is the one obtained when the wafer stage 7 is driven so that the alignment mark 12 formed in each sample shot is positioned at the measurement position of the detector 9, based on design data of shot array. The alignment mark 12, as illustrated in FIGS. 3A and 3B, is formed on the wafer 1. Statistical processing such as abnormal value processing, or function fitting is performed on the basis of the detected positional displacement amounts, and alignment information such as a shift, magnification, or skew of the wafer from an apparatus reference is acquired. Detection of the above-described positional displacement amounts, performing the statistical processing from the results of the positional displacement amounts and acquisition of the alignment information, as well as controls or processing for these are performed by an arithmetic processing apparatus 16 (control unit). The thus acquired alignment information includes information of a target transfer position for transferring a pattern, and is stored in the arithmetic processing apparatus 16. Concrete detecting method will be described below.

Further, in the operation S22, when the mark 4 of the mold 2 and the stage reference mark 8 of the wafer stage 7 are simultaneously detected by using the detector 6, an amount of mold displacement of the mold 2 may be obtained. The amount of mold displacement means an angle formed between an orientation of the pattern which the mold 2 has, and a driving direction of the wafer stage 7 or a direction of shot array of the wafer 1. For example, the orientation of the pattern which the mold 2 has may be obtained by detecting the marks 4 of the mold 2 at a plurality of locations.

Correction of the amount of mold displacement of the mold 2 obtained here is performed by driving and rotating the structure 3 which holds the mold 2, or by driving and rotating the wafer stage 7 under the control of the arithmetic processing apparatus 16. By performing the correction, imprint operation may be performed while influence of displacement between the pattern which the mold 2 has and rotational direction of shots is reduced.

In operation S23, the wafer stage 7 is driven on the basis of the alignment information including the target transfer position stored in the arithmetic processing apparatus 16. The target transfer position set on the wafer is moved to a position under a coating unit (not illustrated), and is coated with a resin by the coating unit. In the present exemplary embodiment, photo-cured resin is used as the transfer material.

In operation S24, the shot coated with resin in operation S23 is fed under the mold 2, by driving the wafer stage 7 under control of the arithmetic processing apparatus 16, on the basis of the alignment information acquired by the global alignment measurement in operation S22. The wafer stage 7 is driven based on coordinates of the target transfer position with respect to each shot calculated on the basis of the alignment information, and a baseline amount measured by using the detector 6 or the detector 9. Accordingly, the target transfer position coated with the resin is fed under the mold 2. These controls are performed by the arithmetic processing apparatus 16.

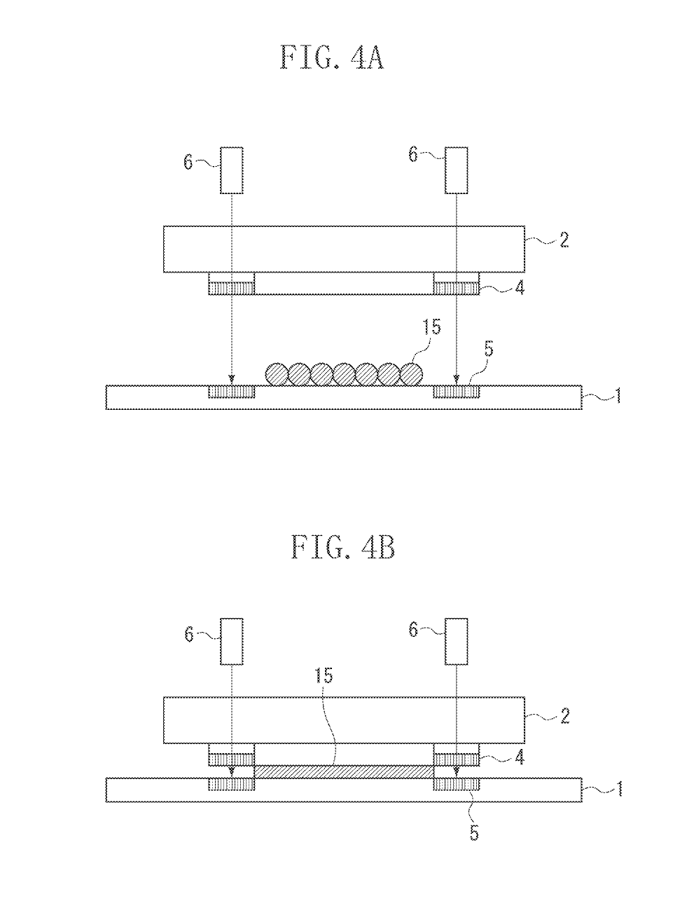

In operation S25, while a resin 15 applied on the wafer 1 and the mold 2 are in non-contact with each other (On-The-Fly), as illustrated in FIG. 4A, the marks 4 of the mold 2 and the marks 5 on the wafer 1 are detected by using the detector 6. The marks 5 are formed around a shot 10 on the wafer 1, as illustrated in FIGS. 3A and 3B. Information indicating relative positions between the marks 4 and the marks 5 is obtained by the arithmetic processing apparatus 16 from the detection results. The information indicating the obtained relative positions is acquired by and stored in an acquisition unit (not illustrated) of the arithmetic processing apparatus 16. The relative position means relative positions between the marks 4 and the marks 5 in a plane perpendicular to the Z-axis when a stamping direction of the imprint apparatus is Z-axis. Concrete measuring method will be described below.

In the present exemplary embodiment, detections of the marks 4 and the marks 5 by the detector 6 may be performed not only in a non-contact state, but also while the resin 15 and the mold 2 are in contact with each other (In Liquid), as illustrated in FIG. 4B. The detection of the marks may be performed during imprint operation until the mold 2 comes into contact with the resin. The marks may be detected while the resin is being cured by irradiating the resin with light or even after the resin has been cured. Further, the detection of the marks is not limited to one time, but may be performed a plurality of times. If the detection is performed a plurality of times, relative positions between the marks 4 and the marks 5 may be obtained with good accuracy, for example, by acquiring an average value with an arithmetic processing system (not illustrated).

In operation S26, a pattern formed on the mold 2 is pressed against the resin applied on the wafer 1. At this time, only the mold 2 or only the wafer 1 may be moved. Alternatively, both the mold 2 and the wafer 1 may be simultaneously moved. At this time, an operation of pressing the wafer stage 7 is performed so as to hold the relative position on the basis of the information indicating the relative positions measured in operation S25. During the operation of pressing, position correction control is performed on the basis of the information indicating the relative positions. The operation of pressing in operation S26, and the position correction control on the basis of the information indicating the relative positions are performed by the arithmetic processing apparatus 16. To the target position of the position correction control, a process factor such as shift, magnification, and an offset which the apparatus has inherently, may be added. The pressing method will be described below in more detail.

Accordingly, even if a reaction force is applied to the imprint apparatus, when the mold is pressed against the substrate via the resin, it is possible to prevent the relative relationship between the position of the mold and the position of the wafer from changing significantly. Therefore, the pattern may be transferred onto the target transfer position obtained by the global alignment process with good accuracy.

Further, the arithmetic processing apparatus 16 may perform position correction control on the structure 3 which holds the mold 2, while performing pressing operation through operation S26, in place of the wafer stage 7. On the other hand, instead of performing control during the pressing operation, after amounts of displacement of both marks of the marks 4 of the mold 2 and the marks 5 on the wafer 1 have been measured On-The-Fly by the detector 6, they may be measured In-Liquid at the time of completing the stamping. The arithmetic processing apparatus 16 drives the wafer stage 7 so that the amounts of displacement measured at the time of In-Liquid match with the amounts of displacement measured at the time of On-The-Fly state.

In operation S27, the resin is cured while the mold 2 and the resin 15 are in contact with each other. In case of imprint method using the photo-curing method, the resin is cured by irradiating it with ultraviolet light. Accordingly, the imprint apparatus is provided with a light source (not illustrated) so that the resin may be irradiated with the light across the mold 2. Further, the mold 2 is made of material through which the light may transmit, such as, for example, quartz that transmits the light. Furthermore, since the marks 4 and the marks 5 are optically observed, the mold 2 needs to be made of material through which the light may transmit. After the resin has been irradiated with the light, the resin on the wafer 1 is molded by withdrawing the mold 2 from the cured resin.

In operation S28, it is determined whether the resin has been molded in all shots on the wafer 1. If there is an unmolded shot (NO in operation S28), in operation S23, the shot is coated with the resin by a coating unit (not illustrated). After the resin has been coated, the pattern may be molded on the resin through the above-described steps. If the unmolded shot is not present in operation S28 (YES in operation S28), in operation S29, the wafer 1 is brought out of the imprint apparatus.

Next, a measurement method to be executed in operation S25 will be described in detail with reference to FIGS. 3A and 3B. FIGS. 3A and 3B illustrate arrangements of wafer marks formed on the wafer 1. FIG. 3A illustrates the shot 10 actually formed on the substrate and the scribe lines 11 formed surrounding the shot. In addition, the marks 5 on the wafer 1 associated with the shot 10, and the alignment mark 12 to be detected by the detector 9 are arranged on the scribe lines 11. FIG. 3B illustrates the shots 10 which are divided into a plurality of regions within one mold 2, and the marks 5 on the wafer 1 associated with the shots 10 are formed on the scribe lines, which divide the regions of the shots 10.

The marks 5 are formed, assuming they will be detected in one-dimensional direction. However, if they are marks which may be detected on two-dimensional basis, a number of the marks may be reduced. The marks 5 formed on the wafer 1 may not be necessarily formed on the uppermost surface, if a plurality of layers has been already formed.

The alignment mark 12 is formed, assuming a two-dimensional mark may be simultaneously detected in X-direction and Y-direction. However, if marks may be detected only in one-dimensional direction like the marks 5, they may be configured to be detected in each of the X-direction and the Y-direction. In the present exemplary embodiment, a direction in which the coating unit (not illustrated) and the mold 2 are aligned is X-direction, and a direction perpendicular to the X-direction on the wafer surface is Y-direction. Arrangements and shapes of the marks 5 and the alignment mark 12 are examples, and they are not limited to the ones illustrated in FIGS. 3A and 3B.

For example, when a simple relative position of the mold 2 and the shot 10 is measured, it may be measured if at least each one location in each of the X-direction and the Y-direction may be detected. Further, as a method for obtaining information indicating relative positions between the mold 2 and the shot 10, for example, the marks 5 on the wafer and the marks 4 of the mold may be detected, and either one may be used as a reference to obtain a displacement amount of the other mark from the reference. As the conceivable displacement amount, a displacement amount in the X-direction and a displacement amount in the Y-direction maybe obtained, or a distance between two marks and a displacement angle relative to a predetermined axis may be obtained. Further, a reference is provided inside the detector 6, and a displacement amount of the marks 5 on the wafer and a displacement amount of the marks 4 of the mold from the reference may be obtained.

As another method, relative positions may also be measured by the detector 6 detecting the marks, without distinguishing between the marks 5 on the wafer and the mark 4 of the mold to obtain only regions of the marks through image processing. Further, if the marks 5 on the wafer and the marks 4 of the mold detected by the detector 6 are partly overlaid, the overlaid region may be obtained to measure relative positions.

Further, information indicating relative positions obtained from the marks 5 on the wafer and the marks 4 of the mold detected by the detector 6 maybe stored in the arithmetic processing apparatus 16. The arithmetic processing apparatus 16 has a function of updating information indicating relative positions obtained for each of different target transfer positions on the wafer. Accordingly, the arithmetic processing apparatus 16 may deal with a case where the relative positions between the target transfer position obtained in operation S22 for each of different shots on the wafer and the marks on the wafer included in the shot corresponding to the target transfer position are different from each other.

In the imprint apparatus, change of relative positions between the substrate and the mold occurs when the resin applied on the substrate and the mold come into contact with each other. Therefore, it is only necessary to perform control of the above-described relative positions after at least the mold and the resin applied on the substrate have come into contact with each other. Furthermore, as for the above-described control, a control of the relative positions needs to be completed before the resin is cured by irradiating with light. As for the control method, stamping operation given in operation S26 in FIG. 2 will be described in detail.

Until the mold 2 comes into contact with the resin after starting the descent from On-The-Fly position, the mold 2 is lowered under position control by the arithmetic processing apparatus 16. At this time, an imprint control unit may perform, or may not perform position correction control of the wafer stage in real time to retain relative position measured at the On-The-Fly position.

After mold 2 descends, and makes contact with the resin, the mold 2 is controlled by a force control. More specifically, stamping is performed to attain a predetermined pressure (F), and after reaching the predetermined pressure, a predetermined waiting time (t) may be taken in order to wait for the fill of the resin. As for values of the pressure (F) and the time (t), it is desirable to derive appropriate values for forming a transfer pattern from experiments.

As for contact between the mold and the resin, it may be recognized that the mold and the resin have come into contact with each other, for example, by detecting driving current of a driving mechanism (not illustrated) for driving the structure 3 which holds the mold. In addition, as feasible methods, atmospheric pressure change of a closed space inside the structure which holds the mold may be sensed, pressure or strain may be detected by providing a sensor on the mold, or a through current caused by contact may be sensed by measuring an electric resistance between the mold and the wafer.

With regard to control of relative positions, it is only necessary that the position correction control be performed, after at least the mold and the resin have come into contact with each other. As the method for control of relative positions, when the mold and the resin comes into contact with each other, simultaneously the position correction control may be started, or the position correction control may be performed during the time waiting for the fill of the resin, after the contact is made. Alternatively, if the position correction control is performed before the contacting operation is started, control may be performed to permit a certain degree of displacements of relative positions before the contact and to narrow a tolerance of displacements with respect to the relative positions after the contacting operation is completed. By doing so, it becomes possible to effectively perform correction control with respect to displacements of the relative positions made during the contacting operation.

In the above-described exemplary embodiment, stamping process is performed while the mold and the substrate are parallel with each other. However, when the mold and the resin applied on the substrate are brought into contact, they may be brought into contact while the contact surfaces are not parallel with each other. This is because it becomes easier to fill the resin into a pattern formed on the mold by making non-parallel contact. In such a case, the marks of the mold and the marks of the substrate will be detected at the time of contacting in a state different from the case where the relative positions have been measured in advance at the On-The-Fly position.

Thus, the position correction control starts when the mold and surface of the substrate become parallel with each other, after the mold and the resin have come into contact with each other. By doing so, even when the mold and the substrate are brought into non-parallel contact, relative positions may be detected with good accuracy, and the position correction control may be performed. As a matter of course, in order to transfer the pattern onto the target transfer position, it is also desirable that the mold and the substrate be parallel with each other, when information indicating relative positions between the marks of the mold and the marks on the substrate corresponding to the target transfer position is acquired from the detector 6, while the mold and the substrate are in alignment. Errors in seeing the marks may be reduced by observing the marks after the mold and the substrate have been made parallel.

Alignment information obtained from the global alignment measurement executed in operation S22 includes an amount of shift ShiftX in the X-direction of a shot, and an amount of shift ShiftY in the Y-direction. In addition, the alignment information includes a rotation amount RotX about shot array X-axis, a rotation amount RotY about shot array Y-axis, an expansion/contraction amount MagX in shot array X-axis, and an expansion/contraction amount MagY about shot array Y-axis.

Respective transfer shot positions as target transfer positions may be obtained from the obtained values. For example, transfer shot coordinates X, Y may be expressed by the equation (1) and (2) using shot center coordinates px and py.

X=ps+ShiftX+MagX*px−RotY*py (1)

Y=py+ShiftY+RotX*px+MagY*py (2)

When a resin is applied on a mark formed on the wafer, detection of the mark by the detector becomes difficult. Therefore, in the coating of resin in operation S23, the resin is applied on a shot by the coating unit (not illustrated) to prevent the resin from splashing on the mark formed on the wafer.

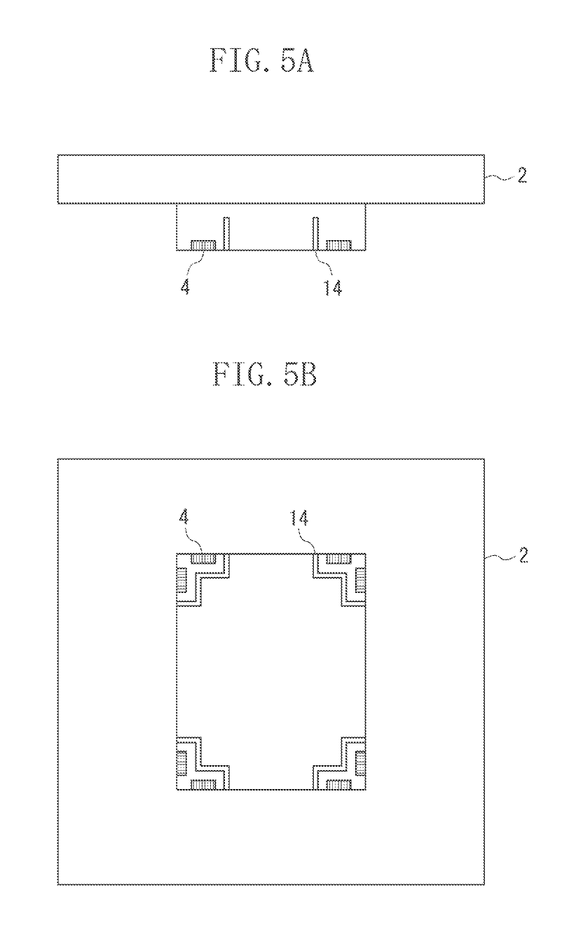

Further, the mold 2 illustrated in FIG. 5 (composed of 5A and 5B) may be used to prevent an excess resin from splashing on the mark at In-Liquid position. FIG. 5A illustrates the mold 2 as seen from a side surface. FIG. 5B illustrates the mold 2 as seen from a surface on which patterns are formed. On the mold 2 illustrated in FIG. 5 (composed of 5A and 5B), grooves 14 called moat are provided. If such a mold is used, the resin is applied on the wafer by the coating unit (not illustrated), to prevent the resin from splashing on the marks formed on the mold 2, and on the marks formed on the wafer. Thus, excess resin flows into the grooves at In-Liquid position, and as a result, splashing of the resin on the marks may be reduced.

Accordingly, even when a reaction force generated when the mold is pressed against the substrate via the resin is applied to the imprint apparatus, the pattern may be transferred with good accuracy onto a shot position obtained by the global alignment process while relative relationship between a position of pattern of the mold and a position of shot may not change.

According to the above-described exemplary embodiment to which the present invention has been applied, correction and transfer are performed, while maintaining measurement values of the global alignment measurement. Thus, influence of deformation of main body structure caused by the reaction force against a stamping force at the time of imprinting, and deformation caused by the stamping force of mold/wafer may be reduced.

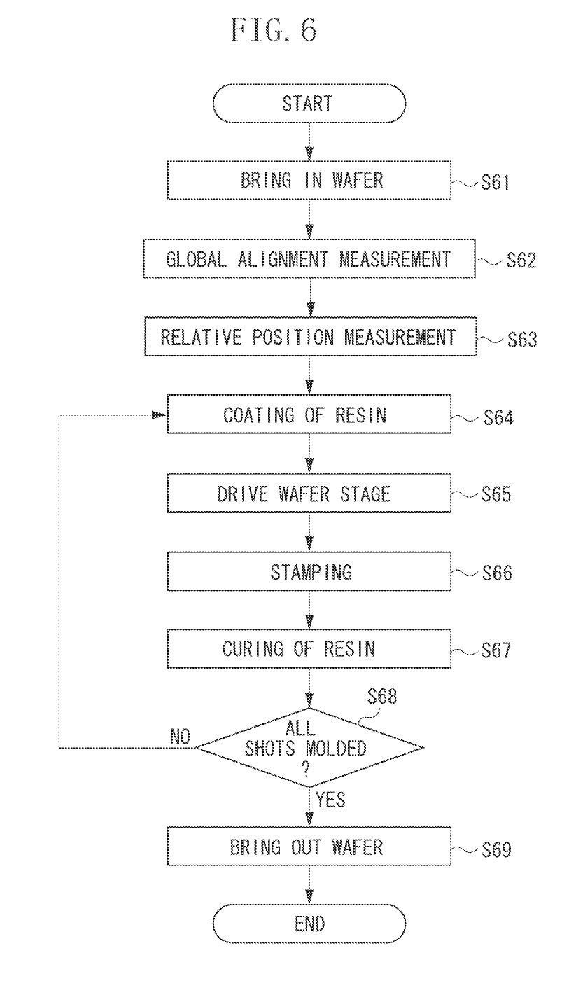

Hereinbelow, a second exemplary embodiment will be described. In the first exemplary embodiment, an example of coating with the resin to avoid the marks on the wafer has been described. However, for example, when positions of the marks 5 on the wafer 1 are close to positions of shots, or when the marks are formed in shot regions, a location for applying the resin is restricted, when the shot is to be coated with the resin. Therefore, the resin may not be uniformly applied at a target transfer position for transferring the pattern. If the resin cannot be uniformly coated, it exerts influence on the pattern to be formed on the wafer. Thus, in the second exemplary embodiment, an imprint method that enables stamping of the mold on the wafer will be described with reference to the flowchart in FIG. 6. In this method, the target position may be held even when the resin is applied on the marks

In operation S61, a new wafer 1 is brought into the imprint apparatus and held by the wafer stage 7. Then, the wafer stage 7 which holds the wafer 1 is moved under the detector 9.

In operation S62, the global alignment measurement is performed. Similarly to the processing in operation S22, the detector 9 optically observes the alignment mark 12 of several typical shots (sample shots) from among a plurality of shots formed on the wafer 1, and calculates positional displacement amount between the measurement position of the detector 9 and the alignment mark 12. Statistical processing is performed on the basis of the results, and alignment information is obtained. Statistical processing is performed on the basis of the calculation of the above-described positional displacement amounts and the results of the positional displacement amounts, to obtain the alignment information. These controls are performed by the arithmetic processing apparatus 16. The alignment information obtained in this process includes information of a target transfer position indicating a location onto which a pattern is to be transferred, and is stored in the arithmetic processing apparatus 16.

In operation S63, the wafer stage 7 is driven, under control of the arithmetic processing apparatus 16, on the basis of alignment information obtained from the global alignment measurement in operation S62, thereby feeding a shot, which is not coated with the resin, under the mold 2. More specifically, the wafer 1 is fed under the mold 2 by driving of the wafer stage 7, according to coordinates of the target transfer position for each shot, obtained on the basis of the alignment information, and the baseline amounts measured by the detector 9.

Then, similarly to the processing in operation S25, the marks 4 of the mold 2 and the marks 5 on the wafer 1 are detected by using the detector 6. From the detected results, information indicating relative positions between the marks 4 and marks 5 is obtained by the arithmetic processing apparatus 16. The obtained information indicating the relative positions is acquired by and stored in the arithmetic processing apparatus 16. Here, the relative position indicates, when a stamping direction of the imprint apparatus is Z-axis, relative position between the marks 4 and the marks 5 in a plane perpendicular to the Z-axis.

Difference between operations S25 and S63 is whether the marks are detected when a shot is coated with the resin, or detected before the resin is applied. Before the resin is applied on the wafer, the marks 4 of the mold and the marks 5 on the wafer are detected On The Fly by the detector 6, thereby obtaining relative positions for all shots. The information indicating relative positions obtained through measurements is stored in the arithmetic processing apparatus 16 for each shot.

In operation S64, the resin is applied by the coating unit on the target transfer position on the wafer. In this process, it is not necessary to control the coating unit to prevent the resin from splashing on the marks as in the first exemplary embodiment. Since the relative position measurement has been performed On The Fly already in operation S63, the resin may be applied on the marks.

In operation S65, the wafer stage 7 is driven, under the control of the arithmetic processing apparatus 16, according to the alignment information, obtained from the global alignment process measurement in operation S62, thereby a target transfer position on which the resin has been applied in operation S64 is fed under the mold 2.

In operation S66, a pattern formed on the mold 2 is pressed against the resin applied on the wafer 1. An operation is controlled by the arithmetic processing apparatus 16. At this time, similarly to the first exemplary embodiment, either the mold 2 or the wafer 1 may be moved, or both may be simultaneously moved.

If the resin is splashed on the marks 5 on the wafer in operation S64, detection of the marks 5 by the detector 6 On The Fly becomes difficult. However, since difference of refractive indices between the resin and the mold is small, the resin is filled between the marks 5 on the wafer and the mold, and when the detector and the marks come close to each other, the marks maybe detected. In the present exemplary embodiment, by using transparent resin, the marks 5 on the wafer may be detected by the detector 6 through the mold, when the resin and the mold come into contact with each other.

On the other hand, as to the marks of the mold used in the imprint apparatus, unevenness provided on a pattern surface of the mold is used as a mark. As a consequence, there is a problem that it becomes difficult to detect In Liquid the marks 4 of the mold, which may be detected On The Fly. Therefore, while the mold 2 used in the present exemplary embodiment does not require the grooves 14 as in the case of the mold used in the first exemplary embodiment, the mold having the marks 4 vapor-deposited with a metal such as chromium is used so that the marks 4 may be detected In Liquid. By doing so, when the resin and the mold come into contact with each other in operation S66, it becomes possible to detect the marks 4 and the marks 5 by the detector 6. Then, an imprint control unit performs position correction control of the wafer stage 7 in real time, so as to hold relative positions measured before the resin is coated in operation S63.

After that, in operation S67, curing of resin is performed, similarly to the processing in operation S27. In operation S68, it is determined whether the resin has been molded on all shots on the wafer 1, similarly to the processing in operation S28. If unmolded shots are not present, in operation S69, the wafer 1 is brought out of the imprint apparatus similarly to the processing in operation S29.

A method for performing position correction control of information indicating relative positions, or positions in the second exemplary embodiment may also be utilized in the first exemplary embodiment.

Accordingly, even when positions of the marks 5 on the wafer 1 are close to positions of the shots, the resin may be uniformly applied on the target transfer position. Therefore, influence on a pattern to be formed may be reduced.

In the present exemplary embodiment, relative positions of all shots are measured in advance. However, relative positions between the marks 4 of the mold 2 and the marks 5 on the wafer 1 maybe measured before the resin is applied, each time the resin is applied on a shot region. At this time, if there is an unmolded shot, when determining whether the resin has been molded at all shots on the wafer in operation S68 in FIG. 6, in operation S64, coating with resin is performed after the relative position is measured in operation S63.

Further, relative position measurements of arbitrary number of shots maybe also performed in advance. At this time, by applying resin on the shots on which relative position measurements have been performed in advance, a movement amount of the wafer stage 7 for coating with resin and transferring the pattern may be reduced. By reducing the movement amount, throughput is increased. If it takes some time before the pattern is transferred after the resin is applied on the substrate, there is a possibility that characteristics of the resin may change. An arbitrary number of shots may be determined such that they have no effect on characteristics of the resin even when the resin has been applied in advance.

Further, the mold 2 wherein chromium is deposited on the marks 4 which has been described in the second exemplary embodiment may also be used in the first exemplary embodiment. A displacement amount of the mold 2 and a displacement amount of the shots on the wafer 1 are measured and corrected during an imprint operation. By doing so, even if the imprint operation is performed on a plurality of shot regions, the pattern of the mold may be transferred onto positions of the shots by the global alignment measurement.

A manufacturing method of devices (e.g., semiconductor integrated circuit element, liquid crystal display device) as articles includes an operation of forming the pattern on the substrate (wafer, glass plate, film-like substrate) by using the above-described imprint apparatus. Furthermore, the manufacturing method may include an operation of etching the substrate on which the pattern has been formed. If other articles such as patterned media (recording medium) or optical elements are manufactured, the manufacturing method may include other types of processing of the substrate on which the pattern has been formed, in place of etching. An article manufacturing method according to the present exemplary embodiment is more advantageous in terms of at least one of performance, quality, productivity, production cost of articles, as compared with the conventional method.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-230648 filed Oct. 13, 2010, which is hereby incorporated by reference herein in its entirety.

What is claimed is:

1. An imprint apparatus that transfers a pattern formed on a mold to a transfer material provided in a substrate, the imprint apparatus comprising:
a detection unit configured to detect a mark formed on the mold and a mark formed on the substrate corresponding to a target transfer position obtained by detecting a plurality of marks formed on the substrate; and
a control unit configured to obtain information indicating relative position between a mark formed on the mold and a mark formed on the substrate corresponding to the target transfer position, by using a detection result of the detection unit, and to perform alignment between the mold and the substrate by using the information,
wherein the detection unit detects a mark formed on the mold and a mark formed on the substrate corresponding to the target transfer position, in a state where position of the mold and the substrate is aligned before coming into contact each other, in order to transfer the pattern to the target transfer position, and
wherein the control unit obtains information indicating the relative position in the state, and performs alignment between the mold and the substrate so that the relative position when the mold and the transfer material are in contact with each other at the target transfer position, coincides with the relative position in the state.

2. The imprint apparatus according to claim 1, wherein information indicating the relative position is a displacement amount between a mark formed on the mold and a mark formed on the substrate corresponding to the target transfer position.

3. The imprint apparatus according to claim 1, wherein the control unit stores information indicating the relative position when the alignment has been performed, and updates information indicating the relative position obtained for each target transfer position

4. The imprint apparatus according to claim 1, wherein the detection unit, before the transfer material is provided to the target transfer position, while the mold and the substrate are in alignment with each other, detects a mark formed on the mold and a mark formed on the substrate corresponding to the target transfer position, and
wherein after the detection by the detection unit, the transfer material is provided to the target transfer position.

5. The imprint apparatus according to claim 4, wherein the detection unit, before the transfer material is provided to the target transfer position, detects a mark formed on the mold and a mark formed on the substrate corresponding to the target transfer position, with respect to all target transfer positions on the substrate, and
wherein the control unit obtains information indicating the relative positions in the state, with respect to all target transfer positions on the substrate, and performs alignment between the mold and the substrate so that the relative position when the mold and the transfer material are in contact at the target transfer position, coincides with the relative position in the state.

6. The imprint apparatus according to claim 1, wherein the control unit, after the mold and the transfer material have contacted each other at the target transfer position, starts alignment between the mold and the substrate, so that the relative position when the mold and the transfer material are in contact, coincides with the relative position in the state.

7. The imprint apparatus according to claim 1, wherein the detection unit detects a mark formed on the mold and a mark formed on the substrate corresponding to the target transfer position, after the substrate and the mold have become parallel to each other, and
wherein the control unit obtains information indicating the relative position between a mark formed on the mold and a mark formed on the substrate corresponding to the target transfer position, by using detection result of the detection unit.

8. An imprint method for bringing a pattern formed on a mold into contact with a transfer material provided in a substrate, and transferring the pattern to a plurality of target transfer positions obtained by detecting a plurality of marks formed on the substrate, the imprint method comprising:
in a state where alignment between the mold and the substrate is achieved before the contact, in order to transfer the pattern to the target transfer position, detecting a mark formed on the mold and a mark formed on the substrate corresponding to the target transfer position;
obtaining information indicating the relative positions in the state; and
performing alignment between the mold and the substrate so that the relative position when the mold and the transfer material are in contact at the target transfer position, coincides with the relative position in the state.

9. A device manufacturing method comprising:
forming a pattern on a substrate by using an imprint apparatus comprising:
a detection unit configured to detect a mark formed on a mold and a mark formed on the substrate corresponding to a target transfer position obtained by detecting a plurality of marks formed on the substrate, and
a control unit configured to obtain information indicating relative position between a mark formed on the mold and a mark formed on the substrate corresponding to the target transfer position, by using a detection result of the detection unit, and to perform alignment between the mold and the substrate by using the information,
wherein the detection unit detects a mark formed on the mold and a mark formed on the substrate corresponding to the target transfer position, in a state where position of the mold and the substrate is aligned before coming into contact each other, in order to transfer the pattern to the target transfer position, and
wherein the control unit obtains information indicating the relative position in the state, and performs alignment between the mold and the substrate so that the relative position when the mold and the transfer material are in contact with each other at the target transfer position, coincides with the relative position in the state; and
processing the substrate on which the pattern is formed.
